(19) United States
(12) Patent Application Publication
(10) Pub. No.: US 2026/0042496 A1
(43) Pub. Date: Feb. 12, 2026

(54) UNDERCOVER OF ELECTRIFIED VEHICLE

(71) Applicant: TOYOTA JIDOSHA KABUSHIKI KAISHA, Toyota-shi (JP)

(72) Inventor: Eiji ISHIKAWA, Okazaki-shi (JP)

(73) Assignee: TOYOTA JIDOSHA KABUSHIKI KAISHA, Toyota-shi (JP)

(21) Appl. No.: 19/098,181

(22) Filed: Apr. 2, 2025

(30) Foreign Application Priority Data
Aug. 6, 2024 (JP) 2024-129994

(51) Int. Cl. B62D 35/02; B60K 11/08; B62D 25/08

(52) U.S. Cl. CPC B62D 35/02; B60K 11/08; B62D 25/084

(57) ABSTRACT

The undercover includes a cover body and a seal piece. An exhaust port is provided in the cover body. The exhaust port is provided on a downstream side of the cooling fan. A seal piece is disposed in the exhaust port. The seal piece is made of an elastic material. A front end of the seal piece is coupled to the cover body. A rear end of the seal piece extends beyond a rear edge of the exhaust port. A rear end of the seal piece further rides on an outer surface of the cover body. A rear end of the seal piece further biases an outer surface of the cover body upward.

### CROSS-REFERENCE TO RELATED APPLICATION

This application claims priority to Japanese Patent Application No. 2024-129994 filed on Aug. 6, 2024. The disclosure of the above-identified application, including the specification, drawings, and claims, is incorporated by reference herein in its entirety.

### BACKGROUND

### 1. Technical Field

In the present specification, an undercover of an electrified vehicle is disclosed.

### 2. Description of Related Art

In Japanese Unexamined Patent Application Publication No. 2010-81704 (JP 2010-81704 A), a charge control device for an electrified vehicle is disclosed. The electrified vehicle includes a battery pack and a charger. In addition, the electrified vehicle includes a plug for external charging. When a socket of an external charger is inserted into the plug, the charger of the electrified vehicle is activated, and the battery pack is charged.

In addition, a radiator and a cooling fan are provided in a motor compartment in which a rotary electric machine is accommodated. The charger and the battery pack are connected to a cooling pipe. The charger and the battery pack during charging are cooled by a refrigerant flowing through the cooling pipe. Further, a return refrigerant is heat-exchanged in the radiator.

During external charging, the vehicle is stopped. That is, a traveling wind does not enter the motor compartment. Therefore, the cooling fan is driven to cause air to pass through the radiator.

Further, in Japanese Unexamined Patent Application Publication No. 2022-59814 (JP 2022-59814 A), a heat exhaust structure of an undercover is disclosed. A ventilation hole is provided in the undercover. Further, an opening/closing lid is provided in the ventilation hole. The opening/closing lid closes the ventilation hole when exposed to a traveling wind. Meanwhile, the opening/closing lid is rotated by its own weight during congestion or the like. The ventilation hole is opened by the rotation.

### SUMMARY

In the present specification, an undercover of an electrified vehicle is disclosed that suppresses a decrease in a cooling performance of a radiator during charging the vehicle being stopped and can suppress a decrease in aerodynamic characteristics while the vehicle travels.

In the present specification, an undercover of an electrified vehicle is disclosed. The undercover is disposed at a bottom portion of a motor compartment. In the motor compartment, a radiator and a cooling fan are accommodated. In the radiator, a refrigerant is heat-exchanged. The refrigerant flows through a charger. The cooling fan causes air to pass through the radiator. The undercover includes a cover body and a seal piece.

The cover body covers a bottom opening of the motor compartment.

In the cover body, an exhaust port is provided. The exhaust port is provided on a downstream side of the cooling fan.

The seal piece is disposed in the exhaust port.

The seal piece is made of an elastic material.

A front end of the seal piece is coupled to the cover body.

A rear end of the seal piece extends beyond a rear edge of the exhaust port. Further, the rear end of the seal piece rides on an outer surface of the cover body.

Further, the rear end of the seal piece biases the outer surface of the cover body upward.

With the above configuration, the exhaust port is closed by a biasing force of the seal piece. When an air pressure on the downstream side of the cooling fan is higher than an atmospheric pressure due to driving of the cooling fan, the seal piece is pushed up against the biasing force. As a result, the exhaust port is opened. In addition, since an air pressure in the motor compartment and an air pressure below the undercover can be considered equal while the vehicle travels, the exhaust port remains closed.

In addition, in the above configuration, the front end of the seal piece may be coupled to a front edge of the exhaust port.

With the above configuration, a stepped structure between the front end of the seal piece and the cover body can be avoided.

In addition, in the above configuration, the rear end of the seal piece may be thinner than the front end of the seal piece.

With the above configuration, a step between the rear end of the seal piece that rides up from the cover body and the cover body is reduced.

In addition, in the above configuration, the cover body may include a downwardly inclined portion and an upwardly inclined portion. The downwardly inclined portion may be lowered toward a rear of the vehicle.

The upwardly inclined portion may be connected to a rear end of the downwardly inclined portion. In addition, the upwardly inclined portion may be raised toward the rear of the vehicle.

The exhaust port may be provided in a connection region between the downwardly inclined portion and the upwardly inclined portion.

With the above configuration, the exhaust port is provided at a bottom of a mortar structure with the downwardly inclined portion and the upwardly inclined portion. Therefore, the exhaust port can be used as a drain port for water accumulated in the motor compartment.

In addition, in the above configuration, an area ratio of the exhaust port being provided may be higher in the downwardly inclined portion than in the upwardly inclined portion.

The downwardly inclined portion is a surface that is exposed to a traveling wind when the vehicle travels. By making the area ratio of the exhaust port in the downwardly inclined portion high relative to that in the upwardly inclined portion, the seal piece is exposed to the traveling wind. As a result, the exhaust port is reliably sealed when the vehicle travels.

In addition, in the present specification, an undercover of an electrified vehicle is disclosed. The undercover is disposed at a bottom portion of a motor compartment. In the motor compartment, a radiator and a cooling fan are accommodated. In the radiator, a refrigerant is heat-exchanged. The refrigerant cools an in-vehicle apparatus. The in-vehicle apparatus operates during charging. The cooling fan causes air to pass through the radiator. The undercover includes a cover body and a seal piece. The cover body covers a bottom opening of the motor compartment.

In the cover body, an exhaust port is provided. The exhaust port is provided on rearward of the cooling fan in a front-rear direction of the vehicle.

The seal piece is disposed in the exhaust port.

The seal piece is made of a flexible material.

The seal piece opens the exhaust port with an air volume when the cooling fan blows air.

Further, a front end of the seal piece is fixed to the cover body.

With the undercover of an electrified vehicle disclosed in the present specification, the decrease in the cooling performance of the radiator during charging the vehicle being stopped is suppressed. Further, the decrease in the aerodynamic characteristics while the vehicle travels is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overall configuration of an electrified vehicle;

FIG. 2 is a diagram illustrating an internal structure of a motor compartment;

FIG. 3 is a bottom view of the electrified vehicle; and

FIG. 4 is a diagram illustrating an opening process of the exhaust port.

### DETAILED DESCRIPTION OF EMBODIMENTS

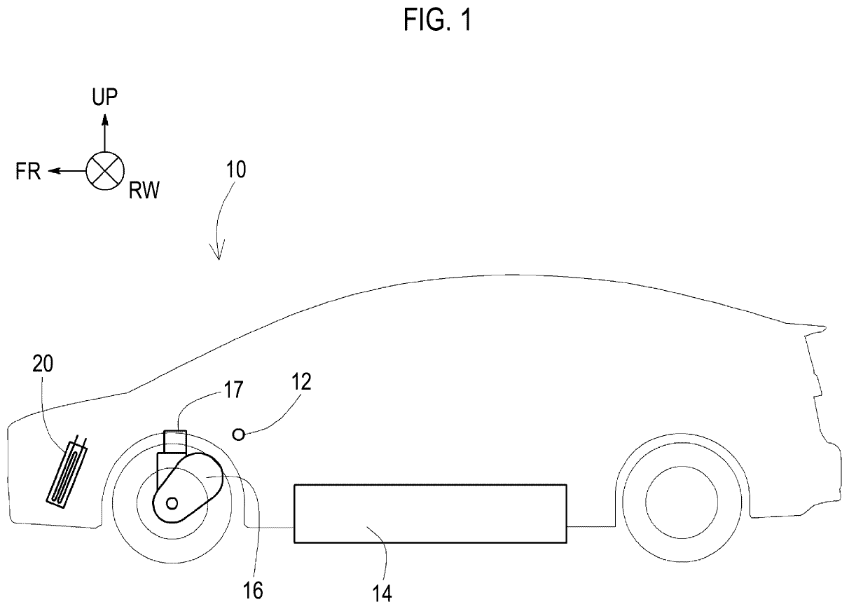

FIGS. 1 to 4 illustrate an undercover of an electrified vehicle according to the present embodiment. In FIGS. 1 to 4, the front-rear direction of the vehicle is indicated by the FR axis. The vehicle width direction is indicated by an RW axis. The vertical direction is represented by a UP axis. The FR axis is a positive direction in front. The RW axis is defined as the positive direction in the right direction. The UP axis is the height direction as a positive direction.

### 1. Entire Configuration

FIG. 1 illustrates an electrified vehicle 10. The electrified vehicle 10 is, for example, a battery electric vehicle (BEV). In addition, the in-vehicle apparatus is illustrated in FIG. 1. The electrified vehicle 10 is equipped with a charging port 12, a battery pack 14, a rotary electric machine 16, a charger 17, and a radiator 20. The electrified vehicle 10 uses the rotary electric machine 16 as a drive source. The battery pack 14 supplies electric power to the rotary electric machine 16.

In addition, the electrified vehicle 10 includes a charging port 12 for external charging. A connector for external charging is connected to the charging port 12. On the electric circuit, the charger 17 is disposed between the charging port 12 and the battery pack 14. The charger 17 is an in-vehicle apparatus that operates when charging is performed. The charger 17 includes an inverter and a DC/DC converter. When the external power, such as household power, is supplied to the charger 17, the charger 17 converts the supplied alternating current power into alternating/direct current power. The converted direct current power is boosted by the DC/DC converter. The direct current power after being boosted is supplied to the battery pack 14.

The charger 17 and the battery pack 14 are cooled during the external charging. A cooling pipe (not shown) is installed in the charger 17 and the battery pack 14. The refrigerant flowing through the cooling pipe is exchanged for heat in the radiator 20 after flowing through the charger 17 and the battery pack 14.

### 2. Motor Compartment

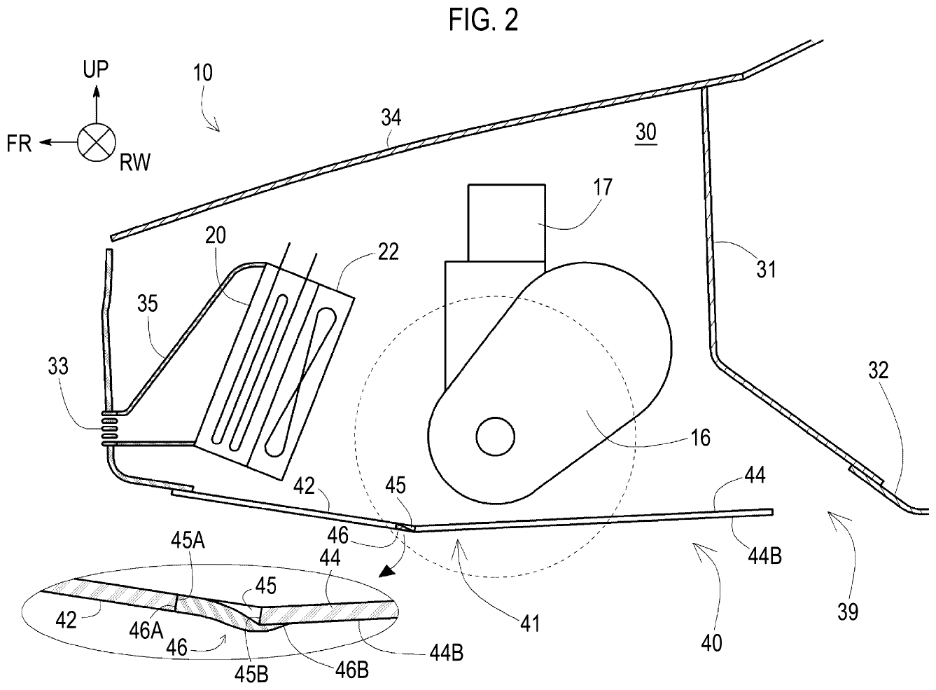

FIG. 2 illustrates an internal structure of the motor compartment 30. In the motor compartment 30, the duct 35, the radiator 20, the cooling fan 22, the charger 17, and the rotary electric machine 16 are housed in this order from the front to the rear of the vehicle.

The motor compartment 30 is a machine compartment provided in front of the vehicle. The motor compartment 30 is surrounded by a front grill 33, a front hood 34, a dash panel 31, and an undercover 40.

The front grill 33 is provided on a front surface of the motor compartment 30. The traveling wind flowing into the front grill 33 is sent to the radiator 20 via the duct 35. The traveling wind and the refrigerant exchange heat with each other in the radiator 20. The traveling wind after the heat exchange passes through the gaps of the rotary electric machine 16 and the charger 17 and is discharged to the outside of the vehicle from the bottom opening 39 and the like.

In order to improve the aerodynamic characteristics, the motor compartment 30 is so-called low-hooded. For example, the radiator 20 and the cooling fan 22 are obliquely disposed in a side view. By being obliquely disposed, the height of the radiator 20 and the cooling fan 22 can be reduced. By the oblique disposition, the air is discharged from the cooling fan 22 obliquely downward in side view. That is, the air from the cooling fan 22 is blown down toward the undercover 40.

Since the power supply cable is connected from the outside during the external charging, the electrified vehicle 10 is stopped. The refrigerant circulates through the refrigerant pipe to cool the battery pack 14 and the charger 17 during external charging.

Since the vehicle is stopped during the external charging, the traveling wind does not enter the motor compartment 30. Therefore, the cooling fan 22 is driven. The cooling fan 22 is disposed behind the radiator 20. The cooling fan 22 is rotationally driven, and air outside the vehicle is drawn in from the front grill 33. As a result, air is passed through the radiator 20.

The flow of air by the cooling fan 22 (intake flow) is weaker than the traveling wind. For example, the flow rate that flows through a gap of the rotary electric machine 16 or the charger 17 is not in the intake flow. Therefore, the drawn flow stays in a space between the cooling fan 22 and the rotary electric machine 16.

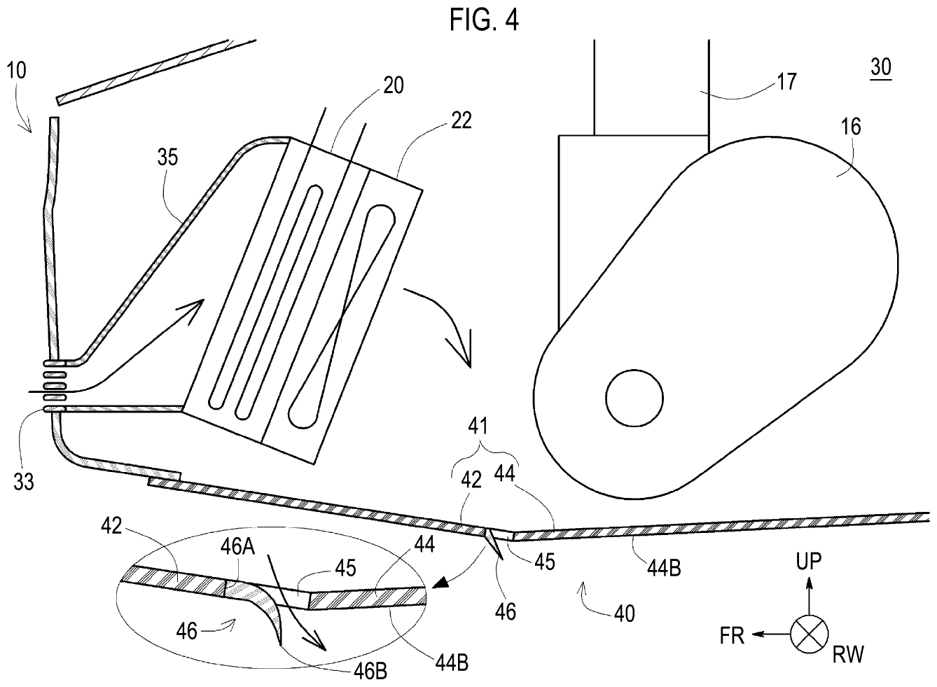

As will be described later, the air stays in a space between the cooling fan 22 and the rotary electric machine 16, so that the air pressure in the space increases. Then, when the difference between the pressure and the atmospheric pressure becomes large, the seal piece 46 (see FIG. 4) of the undercover 40 is turned up. As a result, the exhaust port 45 is opened.

### 3. Undercover

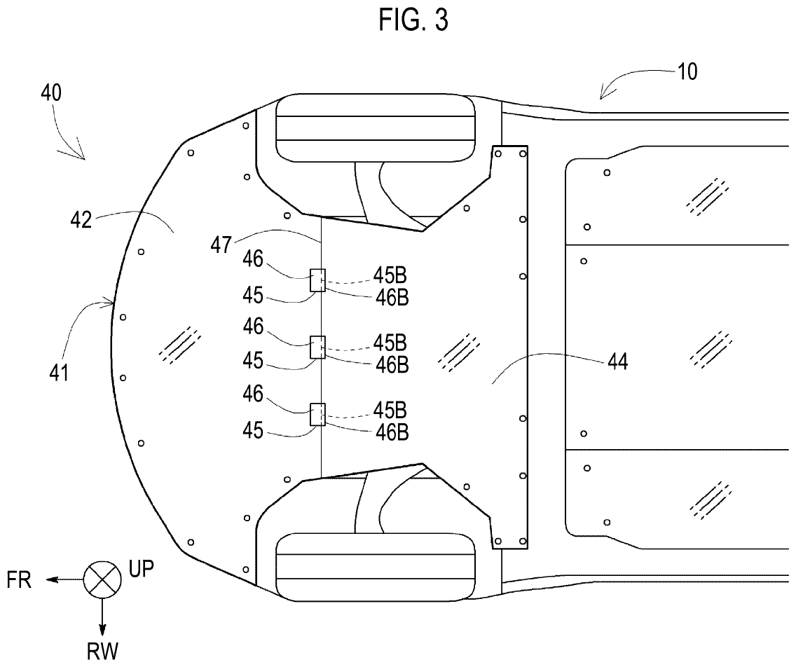

FIGS. 2 and 3 illustrate an undercover 40. The undercover 40 is disposed at the bottom portion of the motor compartment 30. The flat plate-shaped undercover 40 covers the bottom portion of the motor compartment, so that the aerodynamic characteristics are improved.

The undercover 40 includes a cover body 41 and a seal piece 46. The cover body 41 is a flat plate-shaped member. The cover body 41 is made of a resin material such as an ABS resin.

The cover body 41 covers the bottom opening 39 (see FIG. 3) of the motor compartment 30. For example, the cover body 41 covers the bottom opening 39 over the entire surface along the vehicle width direction. On the other hand, with respect to the front-rear direction of the vehicle, a part of the bottom opening 39 is not covered with the cover body 41. For example, a portion of the floor panel 32 downstream of the rotary electric machine 16 and in front of the rotary electric machine 16 is opened from the bottom opening 39 of the cover body 41. The traveling wind that has entered the motor compartment 30 from the front grill 33 is discharged to the outside of the vehicle from the bottom opening 39 through the radiator 20 and the rotary electric machine 16.

The cover body 41 includes a downwardly inclined portion 42 and an upwardly inclined portion 44. The downwardly inclined portion 42 is a front portion of the cover body. The downwardly inclined portion 42 is a downward slope that is lower as moving toward the backward of the vehicle. The upwardly inclined portion 44 is connected to a rear end of the downwardly inclined portion 42. The upwardly inclined portion 44 is an upwardly inclined portion that becomes higher as moving toward the backward of the vehicle. With reference to FIG. 3, a boundary line 47 is provided at a connecting portion of the upwardly inclined portion 44 and the downwardly inclined portion 42. Alternatively, the connection portion between the upwardly inclined portion 44 and the downwardly inclined portion 42 may be subjected to curved surface processing.

That is, the cover body 41 has a mortar shape in a vehicle side view (see FIG. 2). A liquid, such as rainwater, enters the motor compartment 30. The liquid is accumulated in the connection portion of the upwardly inclined portion 44 and the downwardly inclined portion 42 in the cover body 41. As will be described later, the stay liquid is discharged to the outside of the vehicle from the exhaust port 45.

An exhaust port 45 is formed in the cover body 41. The exhaust port 45 penetrates the cover body 41 in the thickness direction. With reference to FIG. 3, the exhaust port 45 is, for example, a rectangular opening. The exhaust port 45 is, for example, a lateral hole in which the vehicle width dimension is longer than the vehicle front-rear dimension. In addition, the exhaust port 45 is formed, for example, in a plurality of the exhaust ports 45 along the vehicle width direction.

The exhaust port 45 is formed on a downstream side of the cooling fan 22. In other words, the exhaust port 45 is provided behind the cooling fan 22 of the vehicle. For example, the exhaust port 45 is formed between the cooling fan 22 and the rotary electric machine 16.

As described above, the air from the cooling fan 22 is blown down toward the undercover 40 by the oblique disposition. In addition, as will be described later, air stays between the cooling fan 22 and the rotary electric machine 16. That is, the space between the cooling fan 22 and the rotary electric machine 16 is an air accumulation where air is blown obliquely downward in side view. The air is discharged to the outside of the vehicle from the exhaust port 45.

In addition, the exhaust port 45 is formed in a connection region between the downwardly inclined portion 42 and the upwardly inclined portion 44. That is, the exhaust port 45 is formed in the bottom portion of the cover body 41, which is in a mortar shape in a side view. For example, during external charging, a liquid, such as rainwater, enters the motor compartment 30. The liquid is accumulated in the bottom portion of the cover body 41. As will be described later, when the internal pressure of the motor compartment 30 is increased, the seal piece 46 is lifted. As a result, the liquid is discharged from the exhaust port 45. In order to quickly move the liquid to the bottom portion of the cover body 41, a guide groove that extends to the boundary line 47 may be formed on the inner surfaces of the downwardly inclined portion 42 and the upwardly inclined portion 44.

The area ratio of the exhaust port 45 being formed may be higher in the downwardly inclined portion 42 than in the upwardly inclined portion 44. For example, in FIG. 3, the exhaust port 45 is formed solely in the downwardly inclined portion 42. That is, the area ratio is 10:0. For example, a rear edge of the exhaust port 45 is disposed on a boundary line 47 between the downwardly inclined portion 42 and the upwardly inclined portion 44.

With reference to FIGS. 3 and 4, the downwardly inclined portion 42 receives the traveling wind because the downwardly inclined portion 42 is an inclined surface facing the front of the vehicle (obliquely front). The seal piece 46 reliably seals the exhaust port 45 by receiving the traveling wind. For example, even when the vehicle travels at a low speed, the exhaust port 45 is formed in the downwardly inclined portion 42 that faces the traveling wind, so that the blockage of the exhaust port 45 is maintained.

With reference to FIGS. 2 to 4, a seal piece 46 is provided in the exhaust port 45. The seal piece 46 is made of an elastic material such as rubber. In other words, the seal piece is made of a flexible material.

With reference to FIG. 3, the seal piece 46 has, for example, a rectangular shape in a plan view. The dimension of the seal piece 46 in the vehicle width direction may be equal to the dimension of the exhaust port 45 in the vehicle width direction. In addition, the vehicle front-rear direction dimension of the seal piece 46 may exceed the vehicle front-rear direction dimension of the exhaust port 45.

In addition, the seal piece 46 may have an uneven thickness in the front-rear direction. For example, a rear end 46B of the seal piece 46 is thinner than a front end 46A. In addition, the thickness of the front end 46A of the seal piece 46 may be equal to the thickness of the cover body 41.

With reference to FIG. 2, a front end 46A of the seal piece 46 is coupled to the cover body 41. For example, the seal piece 46 is coupled (fixed) to the cover body 41 solely at the front end 46A. That is, the side surface and the rear end 46B of the seal piece 46 are movable in the exhaust port 45.

With reference to FIG. 2, a front end 46A of the seal piece 46 is coupled to a front edge 45A of the exhaust port 45. That is, the front end 46A of the seal piece 46 is joined to the inner peripheral surface of the exhaust port 45. For example, a front end 46A of the seal piece 46 is welded to a front edge 45A of the exhaust port 45. With this structure, the seal piece 46 is restrained from protruding from the outer surface of the cover body 41.

The outer surface of the undercover 40 refers to a surface facing the road surface. An outer surface is also referred to as an exposed surface. On the other hand, the inner surface of the undercover 40 refers to a surface facing the equipment in the motor compartment 30.

A vehicle front-rear direction dimension of the seal piece 46 exceeds a vehicle front-rear direction dimension of the exhaust port 45. In addition, a front end 46A of the seal piece 46 is coupled to a front edge 45A of the exhaust port 45. Therefore, the rear end 46B of the seal piece 46 deviates (projects) from the exhaust port 45. With reference to FIG. 2, a rear end 46B of the seal piece 46 extends beyond a rear edge 45B of the exhaust port 45 and further rides on the outer surface of the cover body 41. For example, a rear end 46B of the seal piece 46 rides on the outer surface 44B of the upwardly inclined portion 44.

As described above, the rear end 46B of the seal piece 46 is thinner than the front end 46A. By relatively thinning the protruding portion from the cover body 41, the deterioration of the aerodynamic characteristics can be suppressed.

In addition, the seal piece 46 has a linear shape in an unloaded state. Therefore, in an attitude in which the rear end 46B of the seal piece 46 is raised on the outer surface 44B of the cover body 41, an elastic force (restoring force) due to deformation from the linear shape is generated in the seal piece 46. The elastic force causes the rear end 46B of the seal piece 46 to urge the outer surface of the cover body 41 upward. By the biasing, the exhaust port 45 is sealed by the seal piece 46.

### 4. Operation During External Charging (Exhaust Port Opening Process)

With reference to FIG. 4, in a case of external charging, the electrified vehicle 10 connected to a charging cable maintains a stopped state. The refrigerant is supplied to the charger 17 and the battery pack 14 (see FIG. 1) to cool the charger 17 and the battery pack 14 during external charging. The refrigerant after cooling the equipment is returned to the radiator 20.

The cooling fan 22 is rotationally driven to exchange heat between the refrigerant and the air in the radiator 20. With the driving of the cooling fan 22, the air drawn in from the front grill 33 passes through the radiator 20. Further, the air stays in front of the rotary electric machine 16.

The seal piece 46 opens the exhaust port 45 depending on the air volume of the cooling fan 22 during the air blowing. The air stays in a space between the cooling fan 22 and the rotary electric machine 16, so that the air pressure in the space increases. When the air pressure exceeds the atmospheric pressure, the seal piece 46 is turned up to the outside of the vehicle due to the air pressure difference. That is, the exhaust port 45 is opened. The stagnant air or the stagnant liquid is discharged from the open exhaust port 45.

In addition, when the electrified vehicle 10 travels, traveling wind flows into the motor compartment 30. At this time, the air pressure in the motor compartment 30 and the air pressure between the undercover 40 and the road surface can be considered to be equal. At this time, the seal piece 46 seals the exhaust port 45 by the urging force.

In addition, since the exhaust port 45 is formed in the downwardly inclined portion 42, the seal piece 46 receives the traveling wind. As a result, the exhaust port 45 is firmly sealed with the seal piece. The opening of the exhaust port 45 during traveling is suppressed, so that the deterioration of the aerodynamic characteristic is suppressed.

What is claimed is:

1. An undercover of an electrified vehicle, the undercover being disposed at a bottom portion of a motor compartment in which a radiator where a refrigerant flowing through a charger is heat-exchanged and a cooling fan that causes air to pass through the radiator are accommodated, the undercover comprising a cover body that covers a bottom opening of the motor compartment, wherein:
in the cover body, an exhaust port is provided on a downstream side of the cooling fan;
a seal piece is disposed in the exhaust port;
the seal piece is made of an elastic material;
a front end of the seal piece is coupled to the cover body;
a rear end of the seal piece extends beyond a rear edge of the exhaust port and rides on an outer surface of the cover body; and
further, the rear end of the seal piece biases the outer surface of the cover body upward.

2. The undercover according to claim 1, wherein the front end of the seal piece is coupled to a front edge of the exhaust port.

3. The undercover according to claim 1, wherein the rear end of the seal piece is thinner than the front end of the seal piece.

4. The undercover according to claim 1, wherein:
the cover body includes
a downwardly inclined portion that is lowered toward a rear of the vehicle, and
an upwardly inclined portion that is connected to a rear end of the downwardly inclined portion and is raised toward the rear of the vehicle; and
the exhaust port is provided in a connection region between the downwardly inclined portion and the upwardly inclined portion.

5. The undercover according to claim 4, wherein an area ratio of the exhaust port being provided is higher in the downwardly inclined portion than in the upwardly inclined portion.

6. An undercover of an electrified vehicle, the undercover being disposed at a bottom portion of a motor compartment in which a radiator where a refrigerant that cools an in-vehicle apparatus operating during charging is heat-exchanged and a cooling fan that causes air to pass through the radiator are accommodated, the undercover comprising a cover body that covers a bottom opening of the motor compartment, wherein:
in the cover body, an exhaust port is provided rearward of the cooling fan in a front-rear direction of the vehicle;
a seal piece that covers the exhaust port from below the cover body is disposed;
the seal piece is made of a flexible material that opens the exhaust port with an air volume when the cooling fan blows air; and
a front end of the seal piece is fixed to the cover body.
